(19) United States
(12) Patent Application Publication
(10) Pub. No.: US 2017/0122344 A1
(43) Pub. Date: May 4, 2017

(54) CONNECTING APPARATUS

(71) Applicant: HYDAC TECHNOLOGY GMBH, Sulzbach/Saar (DE)

(72) Inventors: Sascha Alexander BIWERSI, Mettlach (DE); Marcus HETTIGER, Saarlouis (DE); Christoph STOENNER, St. Ingbert (DE)

(21) Appl. No.: 15/318,389

(22) PCT Filed: Jun. 2, 2015
(86) PCT No.: PCT/EP2015/001118

§ 371 Date: Dec. 13, 2016

(30) Foreign Application Priority Data
Jun. 13, 2014 (DE) 10 2014 008 648.8

(51) Int. Cl. F15B 13/02

(52) U.S. Cl. CPC F15B 13/02; F15B 2013/002

(57) ABSTRACT

The invention relates to a connecting apparatus, provided for fluid-conducting connection to at least one main component (10), which component has a plurality of mutually adjacent fluid passage points (P′1, P′2, P′3, P′n . . . P′x), said connecting apparatus having a main body (12), which serves to control a fluid flow by means of at least one functional component (14), such as a valve device; a plurality of further fluid passage points (P1, P2, P3, Pn . . . Px), which can be connected to each other in a fluid-conducting manner via the functional component (14) with assignable fluid passage points in the main component (10); and at least one shut-off part, which shuts off the respective fluid passage point (P′2, P′3, P′n . . . P′x−1 in the main component (10) and/or in the main body, said fluid passage point remaining unaffected by the functional component (14). Said connecting apparatus is characterised in that there is in each case a fluid-conducting connection line (30, 32) inside the main body (12) between the further fluid passage points (P1, P2, P3, Pn . . . Px) and the functional component (14), which fluid-conducting connection line can be shut off by a separate shut-off part, as long as the associated connection to the functional component (14) remains unused.

The invention relates to a connection device provided for the fluidic connection to at least one main component, which has multiple mutually adjacent fluid passage points, the component including
a main body which serves to control a fluid flow by means of at least one functional component, such as a valve device,
multiple additional fluid passage points which can be fluidically connected to each other via the functional component with assignable fluid passage points in the main component, and
at least one shut-off part, which shuts off the respective fluid passage point in the main component and/or in the main body, the fluid passage point remaining unaffected by the functional component.

This prior art solution is explained in greater detail in the specific description. In the known solution shown, it is only ever possible to fluidically connect the functional component, for example, in the form of a 2/2 directional control valve, on both its input side and on its output side only ever to one assignable fluid passage point, respectively, in the main body.

However, in order nevertheless to be able to provide a certain modularity in the sense of a so-called LS [load sensitive] control valve assembly unit for mobile work machines, multiple fluid passage points mutually adjacent or assigned in groups to one another were provided in the fluid-supplying main component, which fluid passage points, depending on the number of fluid passage points in the main component to be managed or controlled, must then each be combined with a separate main body, which always has the same functional component and always has the same fluidic line in the area of its output to the last fluid passage point in the main component; but which requires an independent fluid line for each fluid passage point to be controlled on the input side of the functional component, which is not applicable universally, but rather is always assigned to only one particular fluid passage in the main component. Simply put, if one wanted to manage four fluid passage points in the main component with one functional component by means of the main body, a total of four different main bodies would also have to be provided, each with an independent fluid feed line on the input side of the functional component, in order if necessary, to fluidically control any one of the four fluid passage points in the main component. The passage points or fluid connections otherwise remaining open in the main component that are not required are then covered by the housing wall of the main body, at which point a seal is preferably disposed, in order to achieve a sealing, reliable closure to the surroundings in the area of the shut-off assembly.

Based on this prior art, the object of the invention is to further improve the known solution in such a way that the modularity of the overall connecting device is increased in a cost-effective and functionally reliable manner, while maintaining its advantages, such as providing a secure connecting geometry. Such an object is achieved with a connection device having the features of claim 1 in its entirety.

Because, according to the characterizing portion of claim 1, one fluidic connecting line each, which may be shut off by a separate shut-off part if said connection to the functional component remains unused, exists within the base body between the additional fluid passage points and the functional component, each additional fluid passage point in the main body may be individually assigned a shut-off part, so that the fluidic line in the main body that is required or not required, may be arbitrarily opened or shut off in order to be able to connect the functional component to the assignable fluid-supplying fluid passage point in the main component in a functionally reliable manner. This technical solution as such has no equivalent in the prior art and it becomes clear that a plurality of connection geometries can be managed in a functionally reliable manner with only one type of main body having a minimum number of required components, which helps to reduce the costs of the solution.

As a result of the shut-off parts, designed preferably in the manner of so-called ball expanders insertable preferably into the respective lengths of the unneeded connecting lines, it is possible to reliably shut off each unneeded connecting line in the main body to the functional component and, in terms of the sealing connection established, it is possible, depending on for which purposes the connection device according to the invention is to be used, to also omit additional sealing devices on the part of the main body, such as O-ring seals, which are in principle susceptible to failure, which again helps to reduced costs.

The connection device solution according to the invention is particularly suitable for controlling channels and channel connections, preferably in the form of control lines, for example, in the form of so-called LS lines in control blocks of mobile work tools and work machines, which are readily charged with pressures up to approximately 400 bar. The connecting length disposed on the output side of the functional component as part of a connecting line may be provided as a direct tank connection to the main component; but may also serve as a continuing control line in the high pressure area if multiple connection devices and their components are overtly assembled to form functional groups.

Both the main component as well as the main body are preferably designed as valve blocks or flange blocks, which can be detachably connected to one another, for example, by a screw fitting.

The subject matter of the invention is also a system consisting of a main body designed preferably as a common part and a main component, as presented in greater detail above.

The solution according to the invention is explained in greater detail below with reference to the drawing, in which

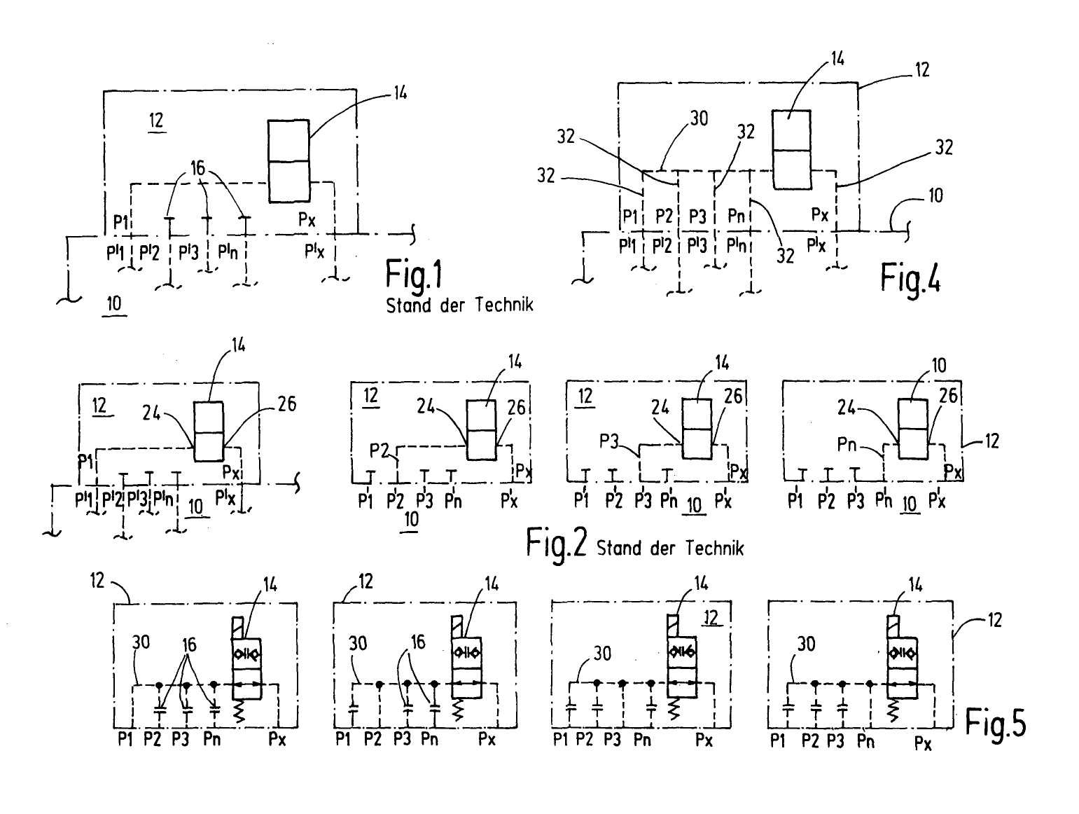

FIGS. 1 and 2 show connection solutions in the form of hydraulic block diagrams as they are shown in the prior art;

FIGS. 4 and 5 show the connection device according to the invention with basic application variants, comparable to the block diagrams according to FIGS. 1 and 2;

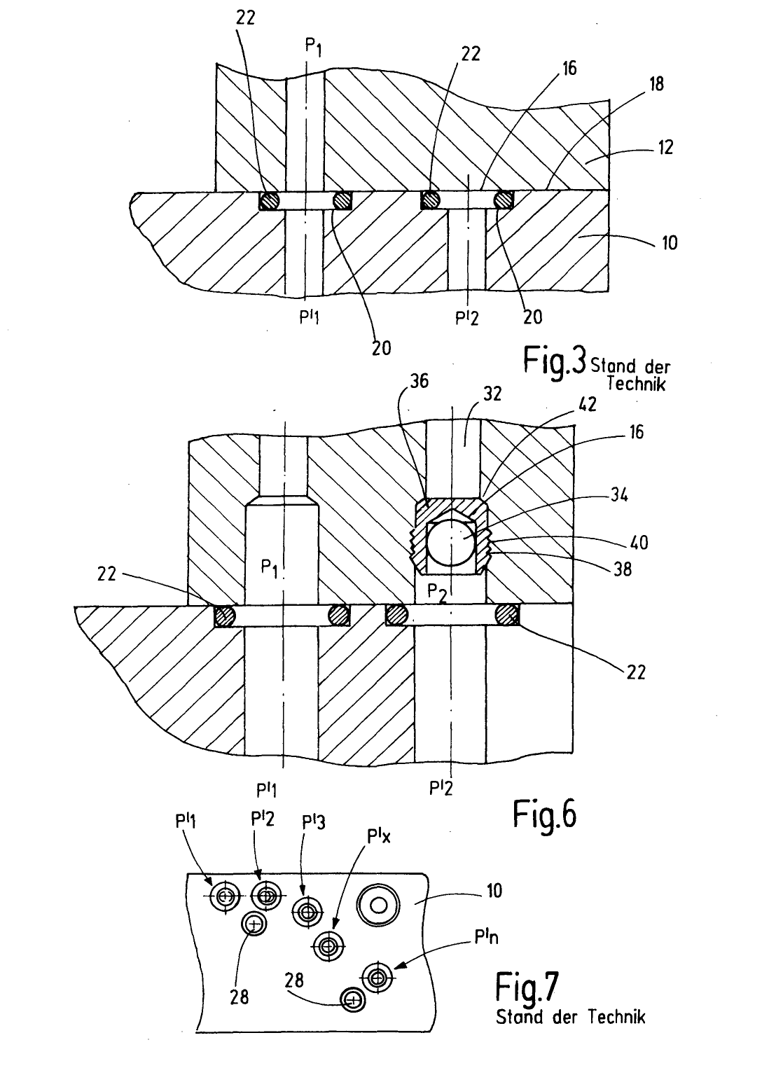

FIG. 3 shows a detail of a connection solution shown in the prior art in a sectional representation;

FIG. 6 shows a connection solution according to the invention comparable to the sectional representation according to FIG. 3, and

FIG. 7 a basic component known per se having multiple mutually adjacent fluid passage points in a top view.

FIGS. 1 and 2 shown complete system connection solutions in the form of hydraulic block diagrams, as they are shown in the prior art. The connection device shown is provided for the fluidic connection to at least one main component 10, which has multiple mutually adjacent fluid passage points P′₁, P′₂, P′₃, P′ₙ . . . P′ₓ. In addition to the main component 10, the connection device has a main body 12, which includes at least one functional component 14 for controlling a fluid flow to be conducted. The functional component 14 may consist, for example, of a valve device, preferably in the form of a 2/2 directional control valve; also in the form of a switch valve or of some other valve device or of some other hydraulic functional group such as, for example, a diaphragm, choke or the like. The main body 12 according to the depiction of FIG. 1 further includes two additional fluid passage points P₁ and Pₓ, which may be fluidically connected via the functional component 14 to the correspondingly assigned fluid passage points P′₁ and P′ₓ in the main component 10. In addition, a shut-off part 16 is present (in this regard, see also FIG. 3), which shuts off the respective fluid passage points P′₁, P′₂, P′₃, P′ₙ . . . P′ₓ₋₁ in the main component 10, so that these passage points remain unaffected by the functional component 14.

The main component 10 as well as the main body 12 are designed in the form of valve blocks or flange blocks, which can be connected to one another in a flange-like manner to form a complete system. In each connected state according to the depictions of FIGS. 1 through 3, the lower housing wall 18 of the flange-like main body 12 forms the shut-off part 16, which covers the fluid passage points P′₁, P′₂, P′₃, P′ₙ . . . P′ₓ₋₁ in a blocking manner. In addition, a fluidic connection according to the depictions of FIGS. 1 and 3 is established between the fluid passage point P′₁ in the main component 10 and the additional fluid passage point P₁ in the main body 12. To achieve a sealing, closing connection between the main component 10 and the main body 12 in the area of the operational fluid passage points P′₁ and P₁, and to shut off fluid passage points P′₂, P′₃, P′ₙ . . . P′ₓ₋₁, radial expansions 20, which permit the insertion of a sealing means, preferably in the form of an O-ring seal 22, are provided at said fluid passage points, wherein each O-ring seal 22 must be inserted, before the flange-like connection between the body 12 and the main component 10 is established. Thus, the respective sealing means opens in the form of the O-ring seal 22 with at least one part of its upper-lying outer contour on one flange side in the form of the lower housing wall 18 of the main body 12 out in the area of the assignable, additional fluid passage points P^{′}₁, P′₂, P′₃, P′ₙ . . . P′ₓ in the connected state of the main body 12 and the main component 120, and is in sealing contact with this wall 18.

In the known solution, as illustrated, in particular in FIG. 2, an independent main body 12 must be provided for each possible controllable fluid passage point in the main component 10, which covers said fluid passage point. Thus, FIG. 2 shows, as viewed from left to right, four different main bodies 12 with functional components 14, each of which controls the assignable pairs of fluid passage points P₁, P′₁; P₂, P′₂; P₃, P′₃ and Pₙ, P′ₙ from the connection geometry on the input side 24 of the functional component 14. The respective additional fluid passage point Pₓ of the main body 12 opens out into the assignable fluid passage point P′ₓ in the main component 10 only on the output side 26 of the functional component 14. In this regard, another passage on the output side could be selected instead of the passage Pₓ, P′ₓ, such as, for example, a combination Pₓ₋₁/P′ₓ₋₁. Thus, according to the depiction of FIG. 2, it would be necessary to control a total of four fluid passage points P^{′}₁, P^{′}₂, P′₃, and P′ₙ with a total of four different main bodies 12, which are all similar and also provided inasmuch with the same reference numeral in FIG. 2, but which nevertheless differ in the configuration of the internal fluidic piping and the connection geometry with respect to the additional fluid passage points P₁, P₂, P₃, Pₙ . . . Pₓ.

The functionalities depicted in FIG. 2 can therefore be implemented by four different flange block processings with different main bodies 12, wherein it is disadvantageous that a total of four block variants differing from one another, depending on their intended use, must be controlled in terms of production technology and logistically and temporarily stored. This is intended to be avoided with the connection device solution according to the invention shown below, wherein for purposes of clarification, it is noted in advance that the respective aforementioned fluid passage points do not, as is shown in principle in FIGS. 1, 2, 4 and 5 in a linear series arrangement, characterize the respective block diagram, but that rather they may also be easily arranged randomly distributed in groups, as this is indicated from FIG. 7 of the prior art, which shows a top view of the fluid connection diagram of a known main component 10 with the fluid passage points P′₁, P′₂, P′₃, P′ₙ . . . P′ₓ. In addition, a portion of the screw fitting 28 is shown in FIG. 7, with which it is possible to connect main component 10 to main body 12 via a screw connection to achieve a mutual contact, wherein the part of the screw fitting 28 according to the depiction of FIG. 7 relates to the engagement thread distances for connection screws not further depicted.

In the device solution according to the invention according to the depictions of FIGS. 4, 5 and 6, a central line 30 extending preferably horizontally is now provided in the main body 12, which replaces the previously variously disposed connecting lines in the flange-like main body 12. The functional component 14 is, in turn, connected in the central line 30, which, previously depicted in the form of a blackbox, is shown in FIG. 5 in the design of a 2/2 directional switch valve, which is controllable by means of an electromagnetic device, for example, in the form of a proportional solenoid and shown in FIG. 5 in the interconnected position. In addition, individual pipelines 32 are shown, which preferably establish the shortest connection in each case between the central line 30 and the respective assignable additional fluid passage points P₁, P₂, P₃, Pₙ . . . Pₓ and which preferably open out perpendicularly into the central line 30.

Thus, as indicated, in particular, from the depiction of FIG. 4, pairs of assignable fluid passage points P₁, P′₁; P₂, P^{′}₂; P₃, P′₃; Pₙ, P′ₙ . . . Pₓ, P′ₓ of main body 12 with main component 12 are implemented via the central line 30 and the individual connected pipelines 32. If, as is suggested by the depiction of FIG. 5, for example, according to the entire left depiction, only one fluid passage point P′₁ is to be connected to the additional fluid passage point P₁, individual shut-off parts 16 are inserted separately from one another into the assignable pipelines 32, in order to thereby shut off the fluid passage points P₂, P₃, and Pₙ. If a fluidic passage via the fluid passage point pair P₂, P′₂ is to be implemented, the shut-off parts 16 are inserted into the pipelines 32 of P₁, P₃ and Pₙ etc., according to the additional two embodiments of FIG. 5. In turn, nothing changes on the output side of the functional component 14 and the output pair Pₓ, P′ₓ remains intact.

If, according to the depiction of FIG. 4, no shut-off parts 16 are inserted, there is also the option of connecting in the manner outlined, in principle, all pairs of fluid passage points that are provided. Nor, for example, does the pressurized fluid connection need to be implemented by the main component 10 via the fluid passage points P′₃, P′ₙ . . . P′ₓ₋₁; instead, there is also the option of implementing other connection concepts (not depicted) in the sense of looping on the input and output side via pairs of fluid passage points of main component 10 and main body 12. There is, in principle, also the option of feeding preferably pressurized fluid via the fluid passage point pair P′ₓ, Pₓ to the main body 12, which then, after passing the connected functional component, in turn delivers the aforementioned fluid flow to the primarily positioned pair of fluid passage points. A variety of variation options are conceivable here with the connection concept according to the invention.

The excerpted detail of FIG. 6 shows a connection solution, as is depicted, for example, to the far left in FIG. 5, in which the passage point pair P′₁ and P₁ are fluidically connected to one another and the additional fluid passage points P₂, P₃, Pₙ are shut off by a shut-off part 16. According to the depiction of FIG. 6, the shut-off part 16 is implemented in the form of a sealing plug, preferably in the form of a ball expander. The expander concept, based on the pressure or expansion principle, utilizes a ball 34 as an expansion element, which is guided in a pot-shaped, expandable holding sleeve 36. By pressing in the ball-shaped expansion element 34, a sleeve expansion is initiated with a backward-rolling gripping of the external teeth 38 surrounding the outer circumference of the holding sleeve 36 to the surrounding wall 40 that surrounds the pipeline 32, which opens downwardly, as seen in the viewing direction of FIG. 6, into the additional fluid passage point P′₂. The expansion process is considered completed once the apex of the ball disappears below the margin of the free, downwardly projecting sleeve upper edge. During the aforementioned deformation of the holding sleeve 36, the edge of the free inlet opening thereof constricts to a degree and to that extent secures the ball-shaped expansion elements 34 against loss.

The shut-off element solution depicted in FIG. 6 is self-sealing per se, so that the previously described and conventional O-ring seals 22 may also be omitted, at least in the area of the inserted shut-off parts 16. If one wishes to introduce the shut-off part 16 at another point, read: inside another connecting length, as per the depictions of FIG. 5, this may be easily implemented by simply introducing the independent shut-off part 16 as a replicate component into the desired pipeline 32 to be used. To achieve a defined contact between the respective shut-off part 16 and the surrounding wall 40, a step-like expansion 42 may be provided in the latter, against which the bottom side of the shut-off part 16 may be supported for the expansion process described.

Thus, with the solution according to the invention, it is possible, as explained, with only one form of the main body 12 to reliably manage a variety of possible fluid connections as part of the connection to a main component 10. In principle, it is the case as demonstrated, that if one wishes to accommodate sealing elements such as O-ring seals in a flange surface, here, that of the main component 10, the space available for this is usually severely limited, wherein it is also a significant disadvantage that corresponding radial expansions 20 must be provided for accommodating the O-ring seals in order not to impede the fluid flow. If, as in FIG. 3, the mutually adjacent opposing flange surfaces of the main component 10 and main body 12 are sealed to the outside by means of the axially acting O-ring seals 22, it is the case that the larger the diameter of the O-ring seal 22, the greater the forces become, which seek to lift the flange block 12 from the support plate of the main component 10 during fluid operation. For this reason, the effort must be made to design the operative surface of the O-ring seals 22 and, therefore, the dimension of the O-ring seals itself as small as possible which, however, has a detrimental effect on the sealing action. The sealing action in particular, is an important aspect specifically in the case of signal lines, since even minimal leakages distort pressures and may therefore cause control errors. Thus, in terms of process stability, a sealing in two fluid flow directions should be guaranteed.

Furthermore, the machining and assembly of the sealing element should be kept as simple as possible, in order not to jeopardize the fundamentally targeted economic advantage. The aforementioned ball expander solution for implementing the respective shut-off part 16 meets all of the requirements outlined above. The installation space required by the ball expander, as demonstrated, requires primarily only a small diameter offset 42, and the aforementioned sealing solution may be physically acted upon even with high pressures without resulting in a malfunction. Furthermore, the shut-off part 16 in the form of the ball expander may be mounted and installed in the assignable pipelines 32 in a rapid and process-stable manner. This is not possible with the present sealing solutions, as they are shown, by way of example, in FIG. 3.

By using a universally drilled block, here in the form of the main body 12, and several sealing elements in the form of ball expanders functioning as shut-off parts 16, it is possible, depending on the block definition, to implement a variety of hydraulic functionalities/logics while including if applicable only two material numbers. Since the aforementioned block 12 is designed as a common part, the production costs are reduced to a significant extent. Furthermore, few components are required to be logistically controlled due to the common part characteristic, and the assembly of the sealing plugs 16 may be optimally coordinated from a manufacturing perspective.

1. A connection device, provided for the fluidic connection to at least one main component (10), which has multiple mutually adjacent fluid passage points P′₁, P′₂, P^{′}₃, P′ₙ . . . P′ₓ, the component including
a main body (12) which serves to control a fluid flow by means of at least one functional component (14), such as a valve device,
multiple additional fluid passage points P₁, P₂, P₃, Pₙ . . . Pₓ, which can be fluidically connected to each other via the functional component (14) with assignable fluid passage points in the main component, and
at least one shut-off part (16), which shuts off the respective fluid passage point P′₂, P′₃, P′ₙ . . . P′ₓ₋₁ in the main component (10) and/or in the main body, the fluid passage point remaining unaffected by the functional component (14).
characterized in that one fluidic connecting line (30, 32) each exists inside the main body (12) between the additional fluid passage points P₁, P₂, P₃, Pₙ . . . Pₓ and the functional component (14), which may be shut off by a separate shut-off pat (16) if the aforementioned connection to the functional component (14) remains unused.

2. The connection device according to claim 1, characterized in that the connecting lines (30, 32) open outwardly from the main body (12) via the respective additional assignable fluid passage points P₁, P₂, P₃, Pₙ . . . Pₓ, and that the respective shut-off part (16) is insertable from the outside into the connecting line (32), preferably remaining there, via the additional fluid passage points P₁, P₂, P₃, Pₙ . . . Pₓ.

3. The connection device according to claim 1, characterized in that the respective shut-off part (16) is formed from a sealing plug, preferably in the form of a ball expander.

4. The connection device according to claim 1, characterized in that the main body (12) is designed in the form of a flange block, which can be connected in a flange-like manner to the main component (10) to form a complete system.

5. The connection device according to claim 1, characterized in that a radial expansion (20) is provided at each fluid passage point P′₁, P′₂, P′₃, P′ₙ . . . P′ₓ of the main component (10), which permits the insertion of a sealing means, preferably in the form of an O-ring seal (22) before the main body (12) and the main component (10) are connected to each other.

6. The connection device according to claim 1, characterized in that the respective sealing means (22) with at least a part of its outer contour opens out on a flange side (18) of the main body (12) in the area of the assignable, additional fluid passage points P₁, P₂, P₃, Pₙ . . . Pₓ in the connected state of the main body 12 and the main component (10) and is in sealing contact with said main body.

7. The connection device according to claim 1, characterized in that the respective connecting lines are made up of a central line (30), into which the functional component (14) is connected, and individual pipelines (32), which preferably establish a shortest possible connection between this central line (30) and the respective assignable fluid passage points (P₁, P₂, P₃, Pₙ . . . Pₓ), extend preferably in a direction perpendicular to the central line (30).

8. The connection device according to claim 1, characterized in that only one fluidic pipeline (32) leads via the central line (30) to the input side (24) of the functional component (14) and, in turn, only one fluidic pipeline (26) on the output side (26) of the functional component (14) is connected via the central line (30).

9. The connection device according to claim 1, characterized in that the functional component (14) is connected into the central line (30) on the output side (26) of the functional component (14) upstream from the pipeline (32) ultimately leading out of the main body (12).

10. A connection device system, made up of a main body (12) and a main component (10) designed preferably as a common part, in each case according to claim 1.
